(19) United States
(12) Patent Application Publication
(10) Pub. No.: US 2015/0253354 A1
(43) Pub. Date: Sep. 10, 2015

(54) METHOD FOR MEASURING SURFACE POTENTIALS ON POLARIZED DEVICES

(71) Applicant: UNIVERSITE DE REIMS CHAMPAGNE, Reims (FR)

(72) Inventors: Louis Giraudet, Reims (FR); Nicolae Bogdan Bercu, Reims (FR); Olivier Simonetti, Reims Cedex 2 (FR); Jean-Louis Nicolas, Reims Cedex 2 (FR); Michael Molinari, Reims Cedex 2 (FR)

(21) Appl. No.: 14/429,306

(22) PCT Filed: Sep. 18, 2013
(86) PCT No.: PCT/FR2013/052140

§ 371 Date: Mar. 18, 2015

(30) Foreign Application Priority Data
Sep. 18, 2012 (FR) 1258747

(51) Int. Cl. G01Q 30/20; G01B 11/30

(52) U.S. Cl. CPC G01Q 30/20; G01B 11/30

(57) ABSTRACT

A method for measuring the surface potential of a polarized sample includes: measuring the topographic profile of the sample by scanning its surface with a tapered tip connected to a micro-lever activated at the resonance frequency of same by a piezoelectric actuator; placing the tapered tip a constant distance away from the topographic profile of the surface obtained during the previous step; and measuring the electrostatic potential of the surface. The sample is not polarized during the step of measuring the topographic profile. The sample is polarized during the measurement of the potential profile.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

1. Field of the Invention

The present invention is related to the field of polarized electronic devices.

The invention relates more particularly to a method for measuring a potential on electronic devices that are polarized through an external voltage source.

More specifically, the present method permits to obtain a nanoscale potential mapping that can namely be applied to semiconductor devices.

2. Description of Related Art Including Information Disclosed Under 37 CFR 1.97 and 37 CFR 1.98.

From the state of the art is presently known to use an Atomic Force Microscope (or AFM for Atomic Force Microscopy) in order to visualize the topography of the surface of a sample, for example a polarized electronic device such as a semiconductor device.

An atomic force microscope is a type of scanning probe microscope, this probe being in the form of a tapered tip. Such a microscope permits to analyze areas having dimensions that can range from a few nanometers to a few micrometers, and to measure forces in the range of the nano-Newton.

Said probe of the AFM microscope is arranged at the level of the free end of a resilient micro-lever, also referred to as “cantilever”. This lever is capable of moving in all the directions in space thanks to a piezoelectric tube, which it is associated with.

During the scanning of the surface of the sample, the bending or deviations of the micro-lever due to attraction or repulsion between the atoms of the apex of the probe and the atoms of the surface of the sample are analyzed. Such analyses permit, on the one hand, a reconstitution of the entire path of the probe and, on the other hand, a measuring of the interaction forces that occur between said probe and the sample.

This finally permits to define the topography of the surface of a material.

The deviations of the lever are traditionally measured by laser reflection. In this case, the probe is mounted on a micro-lever at the surface of which a laser beam is reflected. When the reflected laser beam is deflected, it also corresponds to a deviation of the lever in one direction or the other, which permits to reveal an interaction between the probe and the surface of the sample being analyzed, whereby this interaction can correspond either to an attraction or a repulsion between the two elements, probe and surface being analyzed.

An atomic force microscope may also be used for measuring the value of the electrostatic potential at the surface of the sample to be analyzed, so as to permit to map the surface potential of said sample.

In this specific case, one operates in “KPFM” mode, which in English means “Kelvin Probe Force Microscopy”.

With this method, the measurement of the potential of a surface is performed by two successive passes of the probe at the same spot of said surface. The first pass is performed with the tapered tip of the probe into contact (or intermittently into contact) with the surface to be analyzed and permits a measurement of the topographic profile of the latter. Afterwards, during a second pass, the device uses this topographic measurement in order to place and maintain the probe at a constant height above the surface being analyzed, for example at a distance between 20 and 100 nm, so as to permit to carry out measurements of the electrostatic potential of said surface.

From the document of the state of the art JP 2002 214 113 is thus known a method that permits a topographic measurement and a measurement of the potential, both measurements being performed in “contact” mode, i.e. with a very small distance between the tip of the probe and the surface of the sample, this distance being for example in the range of a few angstroms. Two measurements are performed for each of the points of the surface, and one tries to minimize the interactions between the tip of the probe and the surface of the sample, such that the electrostatic load effect is canceled. The electrostatic load between the tip and the sample is then detected, and a “bias potential” is sent back to the micro-lever in order to minimize the effect of the electrostatic force onto said lever.

However, the traditional methods for measuring the electrostatic surface potential do not permit an optimal analysis, namely as regards the surface of polarized electronic components. This is due to the fact that the known methods do not measure with sufficient accuracy the topographic profiles of a polarized surface during the first pass of the probe, which necessarily affects the second pass aimed at permitting a measuring of the potential of this surface.

It has been put in evidence, according to an inventive step, that the inaccurate measurements of the topography of a surface are mainly due to the fact that, in the case of a polarized sample, a load density can be created either at the surface of this sample or at a very small distance from the latter. The presence of this load density will result into a change in the interaction between the tip of the probe and the surface of the sample, by adding an additional electric force, the Coulomb force. This additional force will cause an attraction or a repulsion of the micro-lever, as would do a change in the height of the surface.

However, the measuring device does not permit to differentiate between an actual change of the topographic profile of the surface and the presence of additional interaction forces due to the polarization of the sample. Hence, the topographical profile being obtained is likely to be distorted. Therefore, the measurement of the surface potential of the probe is also inaccurate, because the height at which this probe is placed during its second pass is set according to the topographic measurements taken during the first pass.

### SUMMARY OF THE INVENTION

The invention provides the possibility of coping with the various drawbacks of the prior art by providing a method that permits to perform particularly accurate measurements of the surface topography of a polarized electronic device, namely a semiconductor device, so that the accuracy of the subsequent measurements of potential is also optimal.

To this end, the present invention relates to a method for measuring the surface potential of a polarized sample, comprising the following steps:
the topographic profile of said sample is measured by scanning the surface of the latter using a tapered tip connected to a micro-lever activated at its resonant frequency by a piezoelectric activator;
said tapered tip is placed at a constant distance with respect to the topographic profile of the surface obtained during the previous step;
the electrostatic potential of said surface is measured;
said method being characterized in that said sample is not polarized during the step of measuring the topographic profile and in that said sample is polarized during the measurement of the potential profile.

Advantageously, said sample is polarized by means of an external voltage source applying a voltage between 0 and ±10V.

The present invention also relates to a device comprising a topography-measuring means and a potential-measuring means using the results of the topography measurement, said device further also including a switch designed to permit the application of a voltage to said sample in closed position and to cancel the application of said voltage in open position, and a synchronization module configured to synchronize the opening and closing of said switch so that the voltage is not applied to the sample during the topographic measurement and is applied to the sample during the measurement of the potential.

According to another peculiarity of the invention, said device includes a tapered tip capable of scanning the surface of a sample polarized through an external voltage source, said tapered tip being connected to a micro-lever capable of being activated at its resonant frequency by a piezoelectric activator and a first generator, said device further including a piezoelectric scanner capable of controlling the positioning of the tapered tip and means for detecting changes in the amplitude of oscillation of the micro-lever, these detection means being connected to a signal-amplifier device, which is, in turn, connected to a casing having as a reference the signal from the first generator, said casing being connected to a device capable of comparing the data being obtained with the reference data, said comparator device being capable of transmitting the data to a feedback loop connected to the piezoelectric scanner, said loop controlling the position of the tip through said scanner, said comparator device being also connected to a second generator capable of supplying a voltage to said micro-lever, said synchronization module being connected, on the one hand, to the feedback loop and, on the other hand, to said external voltage source through said switch.

Interestingly, the device according to the invention also includes an amplifier connected to the second generator and capable of amplifying the voltage supplied by the latter to the micro-cantilever.

The present invention includes many advantages. In particular, it permits to eliminate the topographical artefacts that result into a false measurement of the surface potential of a polarized material. In addition, the present invention is relatively easy to be implemented; indeed, it is only necessary to add to the existing devices a module that permits to synchronize the passes of the tapered tip with the polarization of the polarized material.

Further features and advantages of the invention will become clear from the following detailed description of non-restrictive embodiments of the invention, with reference to the attached figures.

### BRIEF DESCRIPTION OF THE DRAWINGS

FIG. 1 is a schematic view, representing an embodiment of a device for implementing the method according to the invention.

FIG. 2 is a schematic view, representing a measurement of the topographic profile and the electrostatic potential of the surface of a sample to be analyzed.

FIGS. 3A and 3B are schematic views, illustrating respectively a cross-sectional view of a polarized transistor, consisting of a (thin-layer transistor made of organic material), and the voltages applied to the transistor.

FIGS. 4A and 4B are graph illustrations, representing respectively the height (in nm) and the potential (in V) as a function of the position (in μm) of the tip on the sample; these graphs permit to illustrate and compare the topography and the potential of a sample when it is not polarized during the first step of measuring with respect to the same sample that remains polarized throughout the duration of the process.

### DETAILED DESCRIPTION OF THE DRAWINGS

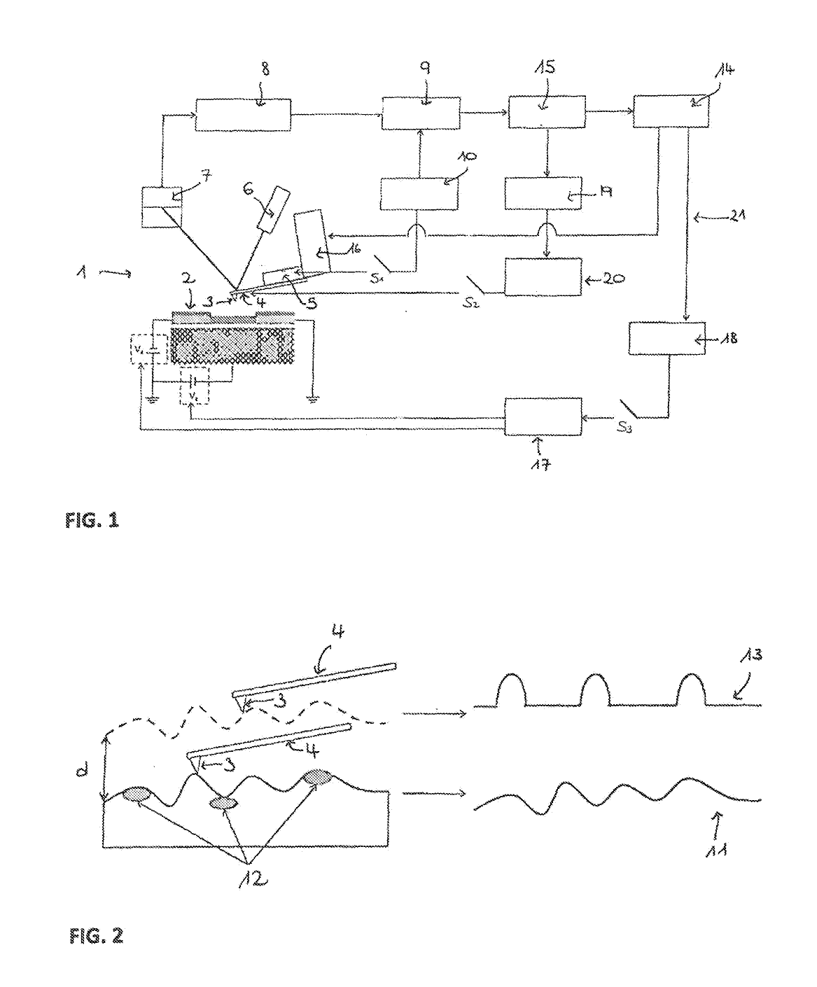

FIG. 1 permits, in a first phase, to schematically illustrate a method implemented in the prior art by means of a device 1 for permitting to measure the topographic profile and the potential of a surface of a sample 2. In particular, the diagram of FIG. 1 represents the state of the art, when the synchronization module 18 and the switch S3 are removed, and when the switches designated by S1 and S2 are respectively closed and open during the measuring of the topographic profile and, inversely during the measuring of the potential.

In particular, in this method, a probe consisting of a tapered tip 3 scans point by point the surface of said sample 2. Such tapered tip 3 is attached to the end of a micro-lever 4 capable of being activated by a piezoelectric activator 5.

Through a first generator 10 applying a signal to the piezoelectric activator 5 (switch S1 closed), the micro-lever 4 can be activated at its resonant frequency, and then oscillates at a determined magnitude; the tapered tip 3 of the micro-lever 4 is then brought into contact with the surface of the sample 2 to be analyzed and a piezoelectric scanner 16 permits to control the positioning of said micro-lever 4 and, hence, of the tapered tip 3.

The interactions between the surface of the sample 2 and the tapered tip 3 vibrating at its resonant frequency will cause a change in the amplitude of oscillation of the micro-lever 4, which oscillates at its resonant frequency.

A laser 6 is preferably used to detect a change in amplitude of oscillation of the micro-lever 4. To this end, the position of the laser beam reflected by said micro-lever 4 is detected by means of a detector 7 including a plurality of quadrants. By way of an example, said detector 7 may namely consist of a split photodiode.

The signals detected by the various quadrants of this detector 7 are then amplified by an amplifier device 8 and returned to a casing 9, which knows as a reference, the signal of the first generator 10 applied to the piezoelectric activator 5. The data relating, on the one hand, to the reflection of the laser beam, representing the oscillation of the micro-lever 4, and, on the other hand, to the signal from the first generator 10, corresponding to the reference oscillating signal applied to the micro-lever 4, are then transmitted to a device 15 permitting a comparison of these data. Any change in amplitude of the oscillation of the micro-lever 4 is thus detected.

In order to distinguish the short-range interaction forces, such as the van der Waals interactions, long-range electrostatic interactions, which occur between the tip 3 and the sample 2, the method is carried out in two steps, as schematically shown in the attached FIG. 2.

In the first step described above, the tapered tip 3 follows the topography of the surface of the sample 2; this results into the detection of a topographic profile 11, shown in the right portion of FIG. 2, and this profile 11 is then recorded.

In a second step, said tapered tip 3 is raised with respect to the surface of the sample 2 and is maintained at a constant distance d from this surface, d being typically of about 100 nm. Following the topographic profile 11 recorded during the first pass, said tip 3 runs over the sample 2 and the system proceeds to a recording of the electrostatic potentials of the surface 12, so as to also obtain a profile 13 of these potentials 12. In order to compensate for the differences between the potential of this tip 3 and the potential of the surface of the sample 2, and to cancel the oscillation of the micro-lever 4 and the tapered tip 3, a voltage is applied to said micro-lever 4 (switch S2 closed). Advantageously, this voltage is applied through a second generator 19, and optionally an amplifier 20, the latter permitting an amplification of the voltage supplied by the second generator.

Depending on measurements that are performed by the device 1, on the one hand, the measurement of the topography and, on the other hand, the measurement of electrostatic potentials, a feedback loop 14 will permit to control the tapered tip 3 of the micro-lever 4. In particular, this feedback loop 14 is connected namely to the data-comparing device 15 and to the piezoelectric scanner 16.

More particularly, during the first step of measuring the topography of the sample 2 to be analyzed, the feedback loop 14 uses the information on the amplitude of oscillation of the micro-lever 4 sent by the casing 9 to the data-comparing device 15. The feedback loop 14 will then generate a response proportional to the difference in amplitude between the reference amplitude and the one being detected, so that the piezoelectric scanner 16 extends or retracts so that the tapered tip 3 is moving away from or closer to the surface of the sample 2, in order to maintain a constant interaction force between said tip 3 and the sample 2. The micro-lever 4 is grounded, and there is therefore no return on the applied voltage.

In the second step of measuring the potentials, the tapered tip 3 follows the pre-recorded topographic profile 11 and, therefore, there is no return on the height positioning of said tip 3.

According to an essential feature of the process according to the present invention, and in order to avoid the topographical artifacts due to a load accumulation in a polarized sample 2 to be analyzed, the latter is not polarized during the step of measuring the topographic profile 11 of the surface of the sample 2. This advantageously permits to avoid an accumulation of loads at the surface of the sample 2 during the measurement of the topography of this surface.

The second phase, in which the measurement of the potential of said surface is proceeded to, is performed in the presence of the external voltages applied to the sample 2. The external voltages produce a polarization of said sample 2, and the measurement of the surface potential profile permits to identify determined features of the sample.

The method according to the invention thus applies in particular to polarizable electronic devices, such as for example, but non-restrictively, semiconductor devices. In other words, a polarizable device corresponds to a device that is polarized in operation, by means of a voltage source, namely an external source.

Particularly preferably, the polarization of the sample 2 at the time of measuring the potential is obtained through an external voltage source 17, schematically shown in the attached FIG. 1. The external voltages applied to said sample 2 through said source 17 permit to put it into its operating condition, which can show a large amount of electrical loads in the vicinity of its surface, these loads being inconsistent with an accurate measurement of the topography.

The external source 17 is advantageously synchronized with the control loop 14 through a synchronization module 18. The connection between said control loop 14 and said module 18 is preferably obtained through a TTL (transistor-transistor logic) outlet 21.

Preferably, a switch S3, visible in the attached FIG. 1, permits the synchronization between loop 14 and voltage source 17: S3 is opened at the time of measuring the topography, and, on the other hand, when measuring the potential, the switch S3 is closed.

Such synchronization between the control loop 14 and the external source voltage 17 permits to ensure that the sample 2 being analyzed is not polarized at the time of the step of topographic measurement, and polarized at the time of measuring the potential profile.

In practice, the topography of a sample 2 is measured line by line. Such measurement generally takes about one second. When the topography of a line is measured, the tapered tip 3 is raised and placed at a constant distance with respect to the topography of the sample 2, the switch S3 is closed and the potential of the line is measured. Then, when the topography and the potential of a line have been analyzed, the device 1 goes to the next line, and the S3 switch is open. Thus, about every second, a voltage should be applied or not in order to polarize or not said sample 2.

Referring now again to the external voltage source 17, this consists of a generator capable of supplying voltages that must be within a range of operation compatible with the second generator 19 and with the eventual amplifier 20; indeed, they must be capable of applying a voltage permitting to cancel the oscillation of the tapered tip 3 at the time of measuring the potential. Typically, the voltages that can be supplied by a second generator 19 are between 0 and ±10V. However, for samples 3 that need to operate at higher polarizations, and that one wants to characterize at higher voltages, this voltage range can be extended by means of an amplifier 20, up to one hundred volts. Further technical solutions should, if necessary, be implemented, for example by working under a vacuum, in order to make possible the extension of this voltage range.

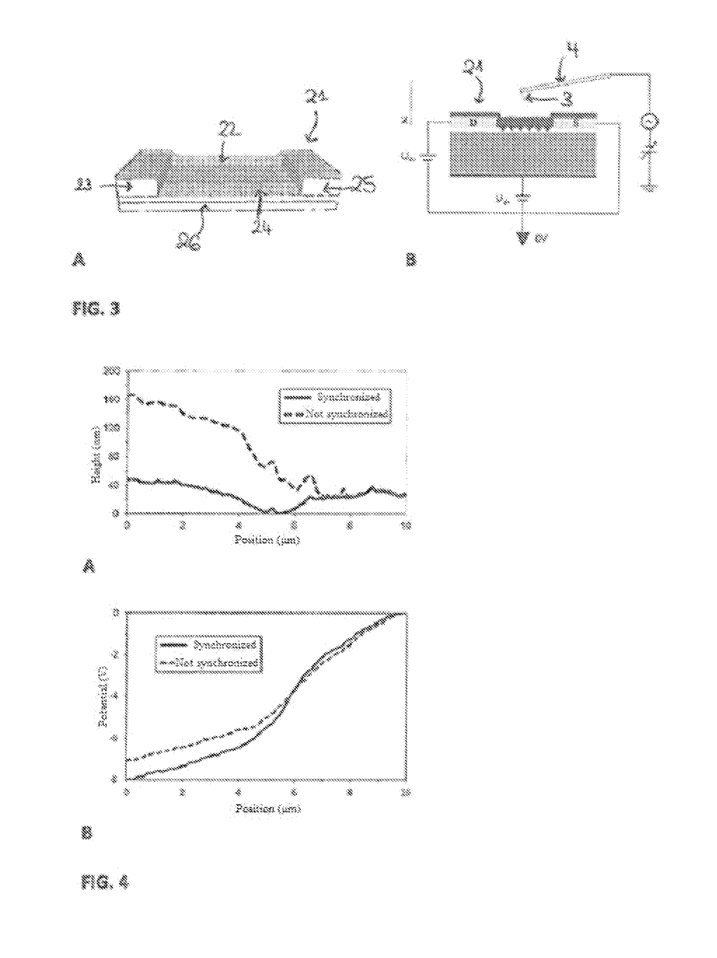

The demonstration of the efficiency of the method according to the present invention is detailed in Example 1 below and in the corresponding FIGS. 3 and 4. This example, aimed at illustrating the interest of the invention, is in no way restrictive as to the scope of the invention described and claimed herein.

The invention also relates to a device 1 for implementing the method described above.

It essentially comprises a topography-measuring means and a potential-measuring means. It uses the results obtained by the topography-measuring means. The device 1 according to the invention also includes a switch S3. The latter is designed so as to permit the application of a voltage to said sample 2 in the closed position and to cancel the application of said voltage in the open position. The device 1 also comprises a synchronization module 18 configured to synchronize the opening and the closing of said switch S3 so that the voltage is not applied to the sample 2 during the topographic measurement, and is applied to the sample 2 during the measuring of the potential.

Preferably, the synchronization module 18 is connected, on the one hand, to the feedback loop 14 and, on the other hand, to said external source of voltage 17, said synchronization module being capable of controlling the switch S3 for its opening or its closing.

More preferably, such a device 1 includes at least:
a tapered tip 3 capable of scanning the surface of a sample 2;
a micro-lever 4 connected to said tip 3;
a piezoelectric activator 5 connected to a first generator 10 in order to activate the micro-lever 4 at its resonant frequency, the latter then oscillating at a determined amplitude;
a piezoelectric scanner 16 capable of controlling the positioning of the tapered tip 3;
means for detecting changes in oscillation of the micro-lever 4; these means consisting preferably of a laser casing 6 and a detector 7, in particular a split photodiode;
an amplifier device 8 connected to the means for detecting the signal;
a casing 9 connected, on the one hand, to the amplifier device 8 and, on the other hand, to the first generator 10, the casing 9 having therefore as a reference the signal from said first generator 10 applied to the micro-lever 4;
a device 15, connected to the casing 9, and capable of comparing the data being obtained with the reference data;
a feedback loop 14 connected to the device 15 and the piezoelectric scanner 16;
a second generator 19 connected to device 15, and eventually to an amplifier 20 for the voltage supplied by said generator 19, this voltage being preferably between 0 and ±10V and being applied to the micro-lever 4 so as to compensate its oscillation and to permit the potential measurements;
an external voltage source 17 for the polarization of the sample 2.

The device 1 according to the invention advantageously permits to synchronize the application or not of a voltage by the source 17 to the measurement of the potential and the topography. In other words, the synchronization module 18 permits not to polarize the sample 2 during the measurement of the topographic profile.

### Example 1

### Demonstration of the Method According to the Invention on a Polarized Electronic Device of the OFET Type

The present method has been implemented on a polarized electronic device, and more particularly on an OFET transistor (Organic Field Effect Transistor) 21, shown in the attached FIG. 3A, and wherein the semiconductor material 22 consists of poly(3-hexylthiophene) or P3HT deposited on an electrode structure forming a transistor.

In particular, the transistors of this type can be subjected to applied voltages that can reach ±100V, which raises problems when measuring their topographic profile.

Said OFET transistor 21 comprises namely three areas of interest 23, 24 and 25.

More particularly, the area 23 corresponds to a constant-potential “drain” electrode, the intermediate area 24 corresponds to the channel of the transistor 21 and the area 25 corresponds to a constant-potential “source” electrode.

The polarization of the transistor 21 is thus external and the voltages applied at the level of the areas of interest 23, 24 and 25 are traditionally not synchronized with the passing of the tip 2; therefore, the step of measuring the topography of the transistor 21 is performed while the latter is polarized.

In the event static loads are present on the sample 21 at the time of measuring the topography thereof, the interaction force between the tip 3 and said sample 21, designated by Fₜᵢₚ, is expressed as follows:

Fₜᵢₚ=F_{VdW}+F_{capi1}+Fₑ₁

In the above formula, F_{VdW}, Fₑ₁ and F_{capi1}, respectively correspond to the van der Waals interaction force, the electrostatic force due to the presence of surface loads and the capillary force due to the humidity of the air. This force may namely be present when the method is implemented at ambient conditions.

In particular, when a component is polarized by a voltage, electric loads are brought to the component by the generator. These loads are likely to create an electrostatic force Fₑ₁ in the vicinity of the surface of the component, thus introducing measurement artifacts that can be interpreted as details of the topography of the surface. According to the traditional method, the topography measurement is performed on a polarized sample, and the force Fₑ₁ will therefore alter the recorded topography profile. The potential profile measured afterwards will therefore also be altered.

According to the proposed method, the topography measurement is performed without external polarization of the component, by canceling the component Fₑ₁.

Once the topographic measurement has been performed, the means for measuring the value of the component Fₑ₁ consists in moving the sharp tip 3 away from the surface by more than 10 nm. Indeed, the van der Waals forces F_{VdW} and the capillary forces F_{capi1} decrease significantly when the distance between the tapered tip 3 and the sample 21 is larger than 10 nm. Generally, said tip is placed at a distance of about 100 nm with respect to the surface, which makes the two components F_{VdW} and F_{capi1} negligible. The external voltages are applied to the component during this second phase.

In order to show the interest and efficiency of the present method, comparative measurements of the topographic profile and surface potential have been performed.

More particularly, in a first phase the topographic profile and the potential of a polarized transistor 21 have been measured, on the one hand, by applying a voltage equal to −15 V between the source 25 and the drain 23 (Uds in FIG. 3B) and, on the other hand, by applying a voltage equal to −15 V between the gate 26 and the source 25 (Ugs in FIG. 3B). These measurements have also been performed on a transistor 21, the polarization of which is synchronized depending on the process step that is implemented, i.e. the voltages applied to the transistor 21 are equal to 0V during the measurement of topographic profile.

The results obtained are shown in FIGS. 4A and 4B.

More particularly, FIG. 4A permits to compare the topographical measurement of a polarized transistor 21 continuously (dotted curve) during the two measurement steps and of the same transistor 21 when the polarization of the latter is synchronized (continuous curve), not polarized during the topographic measurement and polarized during the potential measurement.

It is clearly visible in this figure that the topographical profiles being obtained are different depending on whether the polarization of the transistor 21 is applied or not at the time of the first steps of measurements.

Since the potential measurements are performed while the micro-lever 4 is placed at a constant height according to the pre-recorded surface topography, each topographic artifact recorded during the first measurement step inevitably leads to errors in the potential measurements.

The potential measurements being obtained are shown in FIG. 4B; the dashed curve represents the potentials measured on a continuously polarized transistor 21 and the continuous black curve represents the potentials of a transistor 21 the polarization of which is alternated, said transistor 21 being depolarized at the time of the topographical measurements and polarized during the potential measurements.

This figure permits to illustrate that, since the pre-recorded topography is not accurate, in the case of a continuously polarized transistor 21, the height at which the micro-lever 4 is placed when measuring the potential is not constant with respect to the actual topography of said sample 21. This results into faulty potential measurements.

More particularly, the differences in potential measurements reach more than 12.5% between a transistor 21 the polarization of which is alternated and the same transistor 21 the polarization of which is continuous throughout the measurements of the topography, then of the potential.

It is thus apparent, from the measurements performed experimentally and illustrated in FIGS. 4A and 4B, that the error induced during the step of measuring of the potential by the topographical artifacts is significant and can be corrected through the implementation of the method according to the present invention, namely the synchronized application of a polarization to the sample the surface potential of which one wants to measure.

Of course, the invention is not limited to the examples illustrated and described above, which may exhibit changes and modifications without therefore departing from the scope of the invention.

1. A method for measuring surface potential of a polarized sample comprising the steps of:
measuring a topographic profile of the sample by scanning a surface of the sample using a tapered tip connected to a micro-lever activated at a resonant frequency by a piezoelectric activator;
placing said tapered tip is placed at a constant distance with respect to the topographic profile; and
measuring electrostatic potential of said surface,
wherein the sample is not polarized during the step of measuring the topographic profile, and wherein the sample is polarized during the step of measuring the electrostatic potential.

2. Method for measuring the surface potential of a polarized sample, according to claim 1, wherein the sample is polarized through an external voltage source applying a voltage between 0 and ±10V.

3. Device for implementing the method according to claim 1, comprising:
a topography-measuring means; and
a potential-measuring means using results of the topography measurement;
a switch permitting application of a voltage to the sample in a closed position and cancelling application of said voltage in an open position; and
a synchronization module configured to synchronize opening and closing of said switch so as to cancel application of said voltage to the sample during topographic measurement, and to permit application of said voltage to the sample during the measurement of the potential.

4. Device according to the claim 3, further comprising:
a tapered tip scanning a surface of the sample polarized by means of an external voltage source, said tapered tip being connected to a micro-lever being activated at a resonant frequency by a piezoelectric actuator and a first generator;
a piezoelectric scanner controlling position of said tapered tip; and
means for detecting changes in oscillation amplitude of said micro-lever, the means for detecting being connected to a means for amplifying a signal, said means for amplifying the signal being connected to a casing having a signal from a first generator as a reference, said casing being connected to a means for comparing data being obtained with reference data, said means for comparing data transmitting data to a feedback loop connected to said piezoelectric scanner, said feedback loop controlling position of said tapered tip through said piezoelectric scanner, said means for comparing data being also connected to a second generator supplying a voltage to said micro-lever, said synchronization module being connected, to said feedback loop and to said external voltage source through said switch.

5. Device according to claim 4, further comprising:
an amplifier connected to said second generator amplifying voltage supplied by said second generator to said micro-lever.
